(19) United States
(12) Patent Application Publication
(10) Pub. No.: US 2007/0220102 A1
(43) Pub. Date: Sep. 20, 2007

(54) Digital asset management collaboration system

(76) Inventor: Sam Bogoch, Oakland, CA (US)

Correspondence Address: KALOW & SPRINGUT LLP, 488 MADISON AVENUE, 19TH FLOOR, NEW YORK, NY, 10022, US

(21) Appl. No.: 11/374,562

(22) Filed: Mar. 13, 2006

Related U.S. Application Data
(60) Provisional application No. 60/661,141, filed on Mar. 11, 2005.

(51) Int. Cl. G06F 15/16

(52) U.S. Cl. 709/217

(57) ABSTRACT

A Digital Asset Management system is provided. The Digital Asset Management system, is displayed by means of a login session at a website constructed by software on a server computer system, wherein a portion of the website is devoted to a logo, and/or messaging area, when the user logs in on the system.

### COPYRIGHT NOTICE

A portion of the disclosure of this document contains material that is subject to copyright protection. The copyright owner has no objection to the facsimile reproduction of the patent disclosure, as it appears in the U.S. Patent and Trademark Office patent files or records, but otherwise reserves all copyright rights whatsoever.

This application claims the benefit of the filing date of U.S. Provisional Application No. 60/661,141, filed Mar. 11, 2005, entitled “Digital Image Management and Collaboration System”, this entire disclosure is hereby incorporated by reference into the present disclosure.

### FIELD OF THE INVENTION

This invention concerns a system for the organization and display of digital files representing images, documents and media files, and for letting multiple participants collaborate simultaneously and in real time with messages concerning those files, and perform running amendments to those files. Several examples of related systems, known as Digital Asset Management systems, have been available commercially for over 10 years. The novel Digital Asset Management system to be described herein introduces a number of unique innovations permitting real time collaborative use that are claimed in the present application.

### BACKGROUND OF THE INVENTION

To date, Digital Asset Management products have lacked the ability to present a unified, current view of both the files, or assets as they are known in the art, and the ongoing commentary of messages by participants in the interaction around those files. In addition, Digital Asset Management products have not provided a method for displaying a branding logo, which is determined by the identity of the user who has logged in to the system.

Based on the above, there is a need for new digital management devices and systems that provide new ways to collaborate digital assets over a computer network.

### SUMMARY OF THE INVENTION

The commentary and contribution of multiple participants in a particular workflow is continuously updated in real time. Not only is the time of communicating between individual participants reduced, not by itself a trivial gain, but for the first time, the collaborative creative effects previously possible only with immediate face to face communication, previously only available to participants in the same room, are captured in real time from multiple participants who are not in the same room but are in fact separated by any distances.

In one aspect of the invention there is provided a method for displaying and managing the digital files being continually updated on a shared system. In another aspect of the invention all display and access is provided through a standard Web browser such as Microsoft Internet Explorer, Mozilla Firefox, Apple Safari or the like.

In another aspect of the invention there is provided a method of displaying one or more customer logos for users as they concurrently employ the system.

In another aspect of the invention the selection of the logo(s) to be displayed is dependent on the login username of the user currently accessing the system.

In another aspect of the invention there is provided a messaging capability wherein messages can be posted to refer to individual files, and to one or more folders containing those files.

In another aspect of the invention there is provided a system-wide messaging system wherein individual messages can be viewed in the aggregate at ascending levels of views of the file system, showing only those messages that pertain to the current level.

In another aspect of the invention there is provided a system-wide messaging capability wherein messages can be used as links to individual files, and to assist in navigating one or more levels of folders containing those files.

In another aspect of the invention the system-wide messaging capabilities are connected to standard email protocols so that messages can be copied to external email addresses, and incoming email replies to those messages can themselves be posted as messages.

In another aspect of the system a scripting pull-down menu is provided which offers remote access to an extensible list of standard system scripts such as AppleScript, Unix shell scripts or Microsoft Visual Basic.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### DESCRIPTION OF THE DRAWINGS

FIG. 1 is a layout design for one implementation of the system, showing the onscreen locations of the command area, image display area, message display area and customer logo area.

FIG. 2 is a sample web page showing message display area and digital image as well as files and directories for the users for the above implementation.

FIG. 3 is a sample web page showing message display area and digital image after a user selects one of the digital images for the above implementation.

FIG. 4 is a sample web page showing message display area where the user can place a further message in the message display area in the above implementation.

FIG. 5 is a sample web page showing various user login sessions in the above implementation.

FIGS. 6-7 are sample web pages showing various states of a sample user login session in a second implementation of the system, including different levels of views of the directory system.

FIG. 8 shows a single file as selected, and FIG. 9 shows the message display area where the user can place a further message in the message display area in the latter implementation.

FIG. 10 is a sample web page where a user supplies password and identification to log in at the website.

FIG. 11 is a sample web page in the latter implementation where the message display area has been resized dynamically by the user by dragging a small black icon downward.

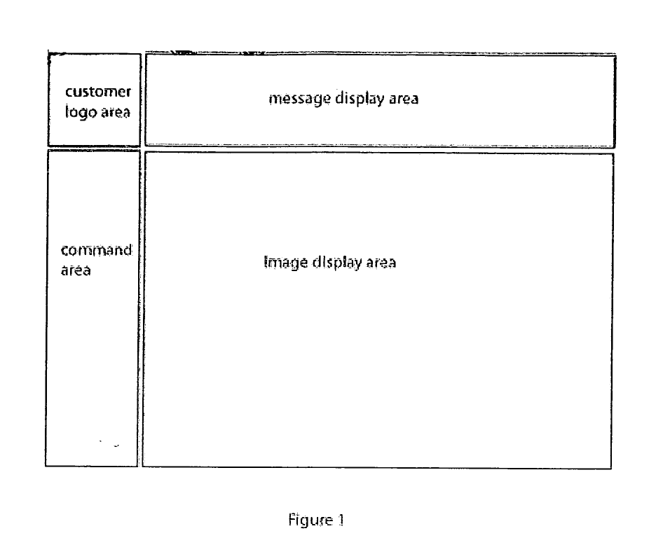

It is to be understood that the figures are not drawn to scale. Further, the relation between objects in a figure may not be to scale, and may in fact have a reverse relationship as to size. The figures are intended to bring understanding and clarity to the structure of each object shown, and thus, some features may be exaggerated in order to illustrate a specific feature of a structure.

### DETAILED DESCRIPTION OF THE INVENTION

Reference will now be made in detail to certain embodiments of the invention, examples of which are illustrated in the accompanying drawings. While the invention will be described in conjunction with the illustrated embodiments, it will be understood that they are not intended to limit the invention to those embodiments. On the contrary, the invention is intended to cover all alternatives, modifications, and equivalents, which may be included within the invention as defined by the appended claims.

The software described herein is installed on a standard computer operating system (in this case, Macintosh OSX version 10.3, but the software is designed to allow alternative implementations for Windows and Linux) along with the following standard open-source utilities—the Apache Web server, the PHP programming language, and the MySQL database. Once Apache, PHP and MySQL have been installed on the operating system, the software described herein can be installed and run as described herein.

The software is intended to run continuously as a server of pages for Web browser access. It continuously scans the file system of the server computer on which it us running, searching for new or modified files within a user-defined top level directory or subdirectories of that directory, and updates the MySQL database to reflect the existence of these files. Users accessing the software through their web browsers can view one or more portions of the file system in the Image Display Area, and can select and view details of individual files.

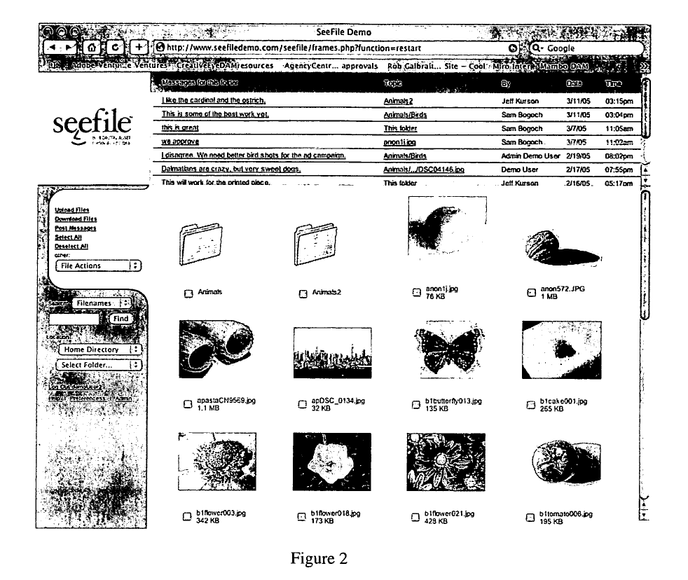

The system provides a standard Web-based login screen, into which the user types their username and password. This gives them access to the main user interface, the current implementation of which is shown in FIG. 2.

The following are descriptions of each of the four main areas of the main user interface.

Customer Logo Area

The Customer Logo Area is used to display a logo specified by the system administrator, which can correspond to the corporate logo of one or more customers who will be using the system. The system allows for multiple Customer Logos to be employed, but for only one to be selected for each user of the software, as a viewing theme when they are using the system.

Command Area

The Command Area contains a number of user-selectable buttons and pop-up menus which drive the functions of the system. These include, but are not limited to the following:

Upload Files allows one or more files on the client computer with Web browser to be uploaded to the areas of the file system currently displayed in the Image Display Area.

Download Files is a button or link which allows one or more files in the Image Display Area to be downloaded to the client computer with Web browser.

Post Messages is a button or link which allows one or more messages to be posted to the Message Display Area as pertaining to the files and system folders shown in the Image Display Area. When Post Messages is selected, the Message Display area is updated to show a message composition window where text can be entered by the user. In addition, a field is provided in the Message Display area at this point to enter one or more email addresses of intended recipients of copies of the message being posted. When the message is posted, the system sends emails containing its text to the intended recipients via standard email protocols. Replies to these emails are processed and parsed by the system and handled as additional messages pertaining to the same files and folders being displayed when the original message was posted.

Select All is a button or link which allows all of the files in the Image Display Area to be selected for subsequent actions to be performed, i.e. downloads or via the Other: File Actions.pulldown menu.

Deselect All is a button or link which allows all of the currently selected files in the Image Display Area to be deselected.

Other: File Actions is a pull down menu which contains a number of additional actions which can be performed on the currently selected files in the Image Display Area. These include, but are not limited to, placing aliases of those files in user-defined collection areas, cutting, copying and pasting files or aliases of files, and transforming files through a variety of image processing routines. The File Actions triggered by this pull down menu are implemented as user-defined functions which can include system scripts using languages such as Unix scripts and AppleScripts.

Typical functions would include modifying the color composition of a file, creating a copy of a file at lower image resolution for use in a different production context, applying anti-aliasing or unsharp masking functions, or other functions commonly used in image processing and preparation.

Search is a text field with accompanying pull down menu and button, allowing the user to specify text, which they intend to search for in the file system, then activate the search. The pull down menu allows the user to specify whether they intend to search for the specified text in the filenames, specified metadata areas, or messages before proceeding with a search.

Location is a multi-level pull down menu, which allows the user to remotely navigate within the file system of the computer running the software. Each level of the pull down menu reflects one level of the folder hierarchy on that file system, and as each of the pull down menus are activated, another level becomes visible beneath the one just activated until a folder is reached which does not contain additional folders. Each time a new selection is made in the Location multi-level pull down is activated, the Message Display Area and Image Display Area update to reflect the currently selected location in the file system.

Log out is a button or link allowing the user to log out of the system.

Help is a button or link, which causes the system to activate a pop-up window in the user's browser containing a standard Web help menu with multiple help topics which can be selected individually for more information about the various aspects of the system.

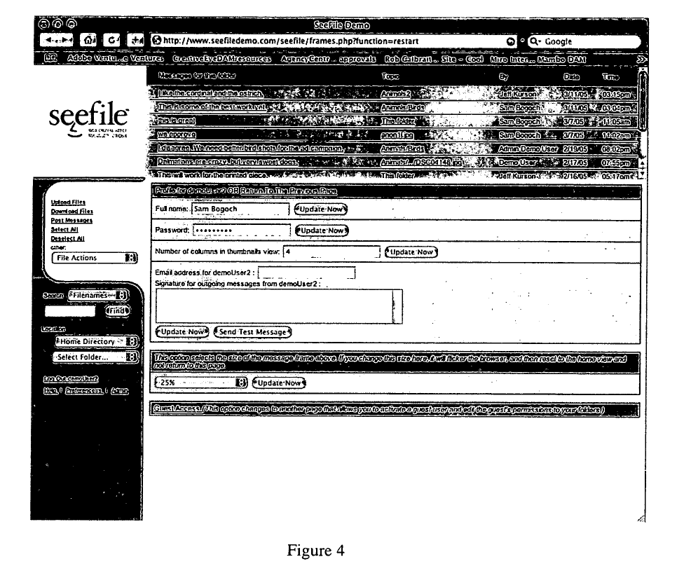

Preferences is a button or link which causes the system to replace the contents of the Image Display Area with a set of user preference settings which can be modified before returning to the main display, as shown in FIG. 4. In the current implementation, these include settings for the number of columns to use for displaying images and folders in the Image Display Area, the password setting for the current user, the full name of the current user (for display as a sender of messages) in the Message Display Area, and options for enabling a guest user with a subset of the current user's authorized permissions.

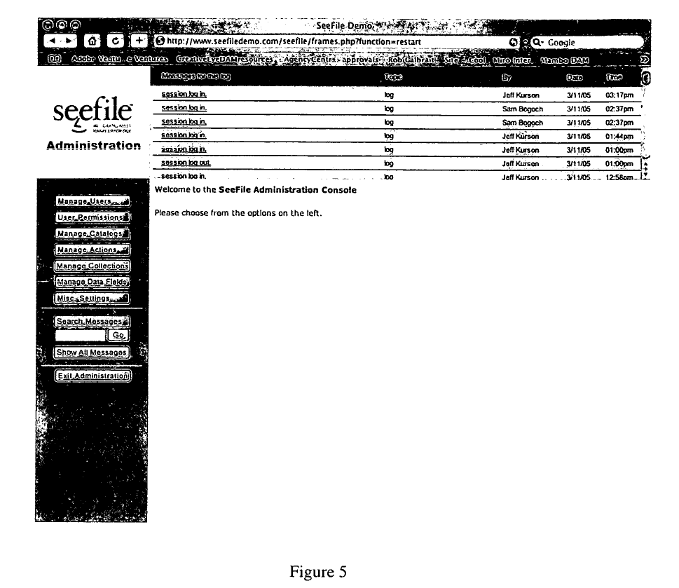

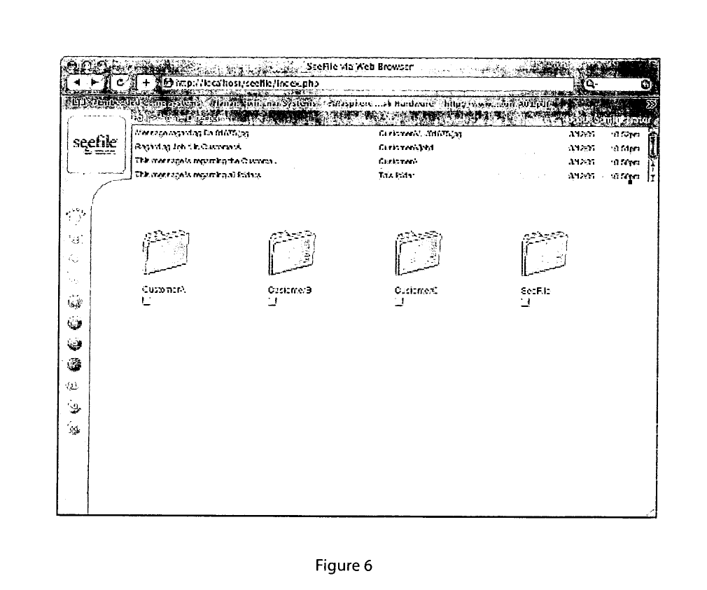

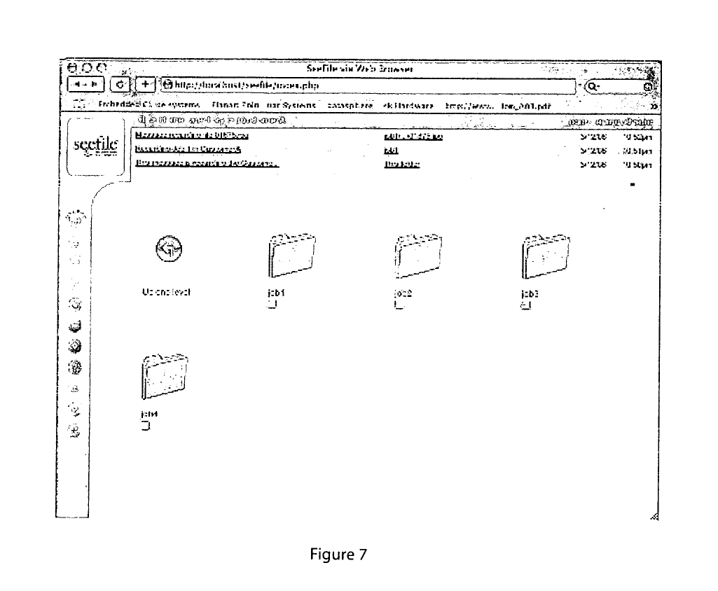

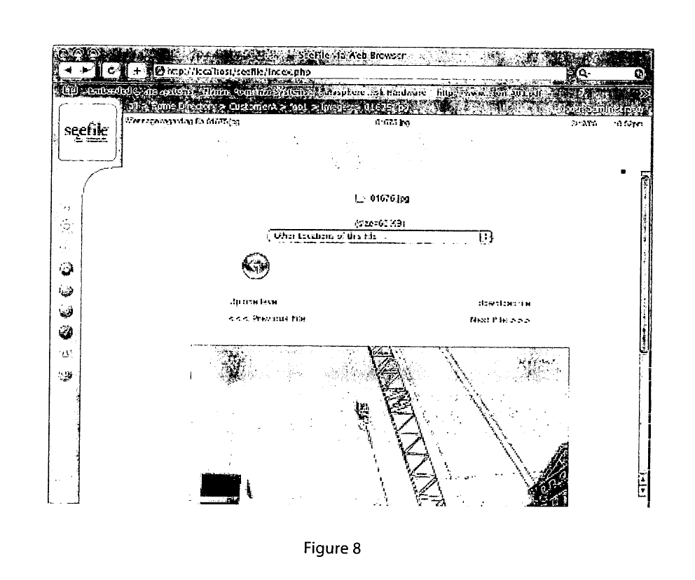

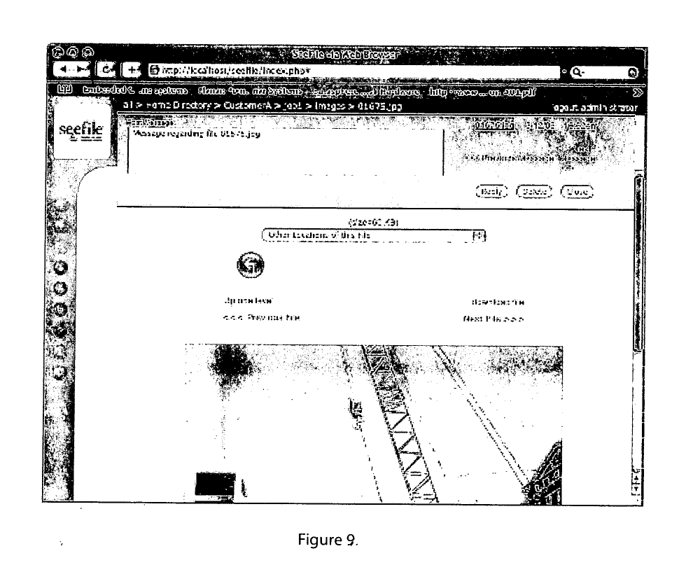

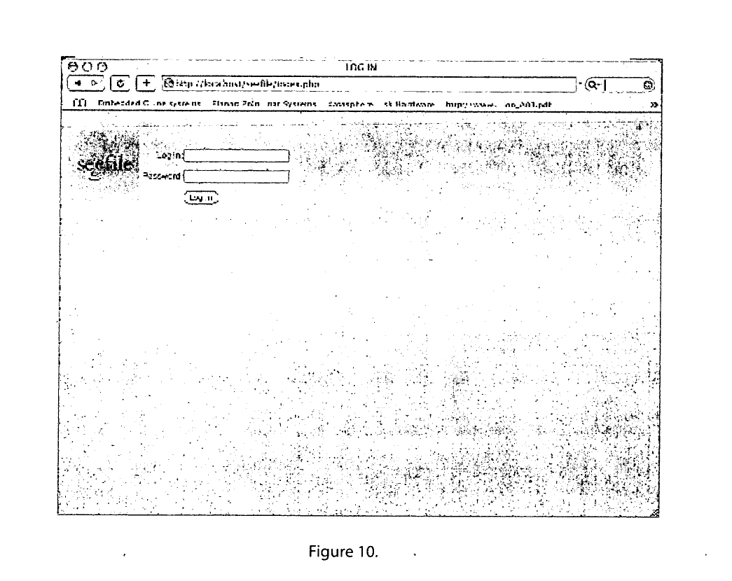

Administration is a button or link, which causes the main display to switch to Administration mode, as shown in FIG. 5. This button is only visible to administrative users of the system.

Image Display Area

The Image Display Area shows the contents (both files and folders) of the area of the file system currently selected through the Search or Location functions in the Control Area. Files are shown as thumbnail-sized images accompanied by the filename and file size, while folders are represented by a folder icon accompanies by the folder name. In addition, each filename has next to it a check box for toggled selection by the user. One or more filenames can be selected or deselected prior to activation of a function in the Command Area such as Download or one of the entries in the Other: File Actions pull down menu.

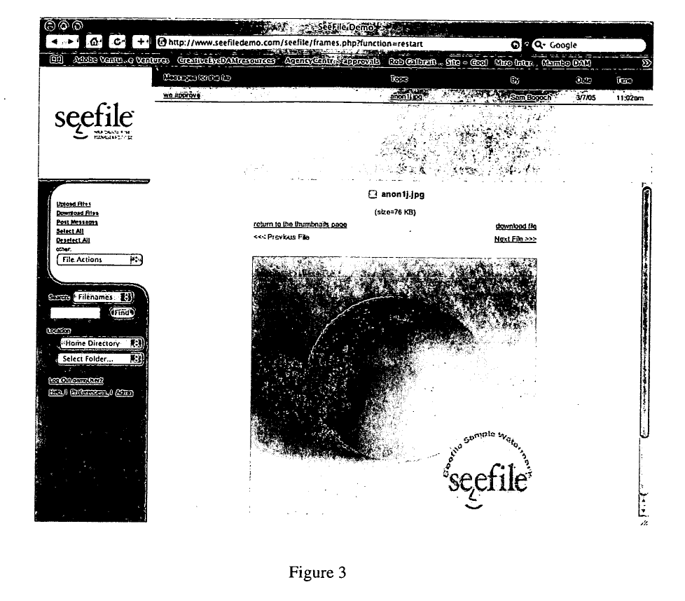

By clicking on the thumbnail-sized image of one of the files displayed in the Image Display Area, the user is able to view a larger, preview-sized image of that file, as well as the MySQL metadata associated with that file. This is shown in FIG. 3.

By clicking on a folder icon displayed in the Image Display Area, the user is able to select and open that folder to view its contents. These contents are then displayed in the Image Display Area, and the Location multi-level pull down menu in the Control Area is updated to reflect the ensuing change of location.

The Image Display Area is currently implemented as a Frame using http Frames technology, so that it can scroll to any length if the number of files and folders exceeds what can be displayed in the user's current browser window. An alternative implementation could employ DHTML or Flash technology to provide scrolling capability, or could also use a non-scrolling technology with a standard pick-list of additional pages of images.

Message Display Area

The Message Display Area shows all messages currently posted which pertain to the selected region(s) of the computer's file system. As the user navigates to different areas of the file system (by clicking on files and folders in the Image Display Area, or by using the pull down menus in the Command Area), the Message Display area is updated to reflect only those messages which pertain to the portion of the file system currently being shown. The Message Display Area is also used at different times: a) to display the full contents of an individual message when it is selected, and b) the full contents of a new message to be composed, after the user clicks the Post Messages button in the Command Area.

Each message is shown as a single line in the Message Display Area's list with fields for the abbreviated text of the message, the name of the sender, the date and time sent, and the pathname of the file or folder to which the message pertains. Clicking on the text of a message causes the system to replace the message list with the full contents of the currently-selected message.

The Message Display Area is currently implemented as a Frame using http Frames technology, so that it can scroll to any length if the number of messages exceeds what can be displayed in the user's current browser window. An alternative implementation can employ DHTML or Flash technology to provide scrolling capability, or can also use a non-scrolling technology with a standard pick-list of additional pages of messages.

In various embodiments, a collaboration system based on Digital Asset Management capabilities is provided. The user utilizes a login session at a website constructed dynamically by software on a server computer system, wherein a portion of the website is devoted to a messaging area, which is present in all views which can be selected by the user. In various embodiments, the messaging area displays only messages which pertain to the folders (directories) or files being displayed concurrently elsewhere in the webpage.

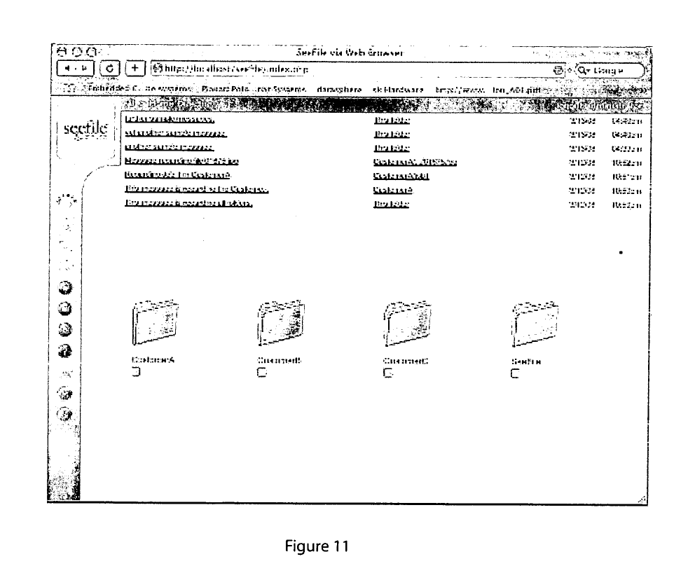

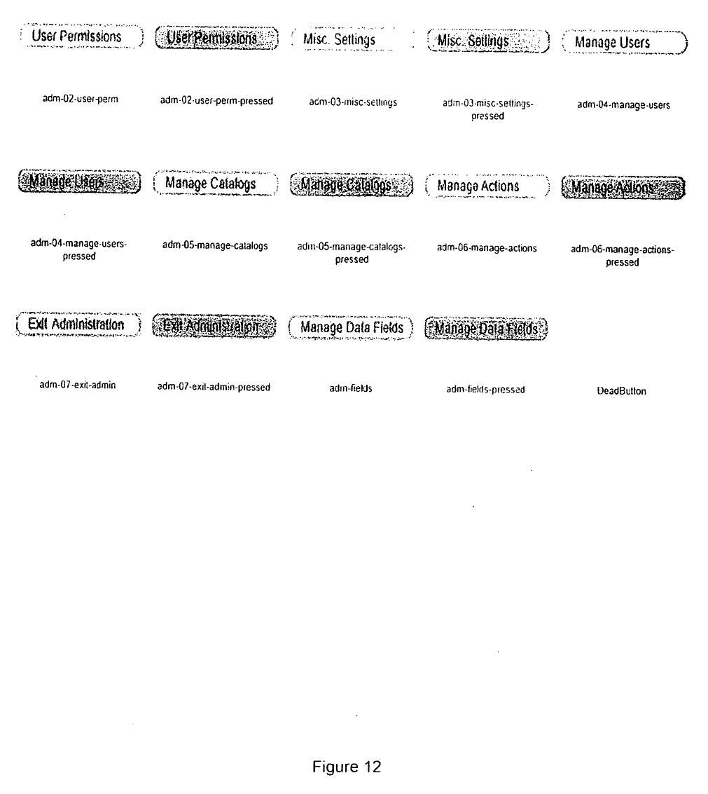

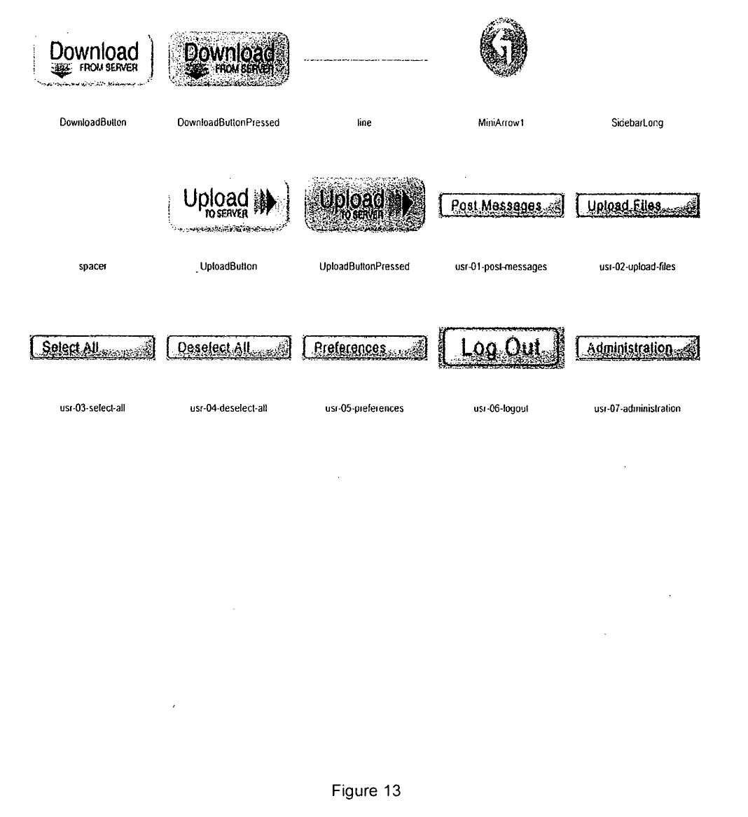

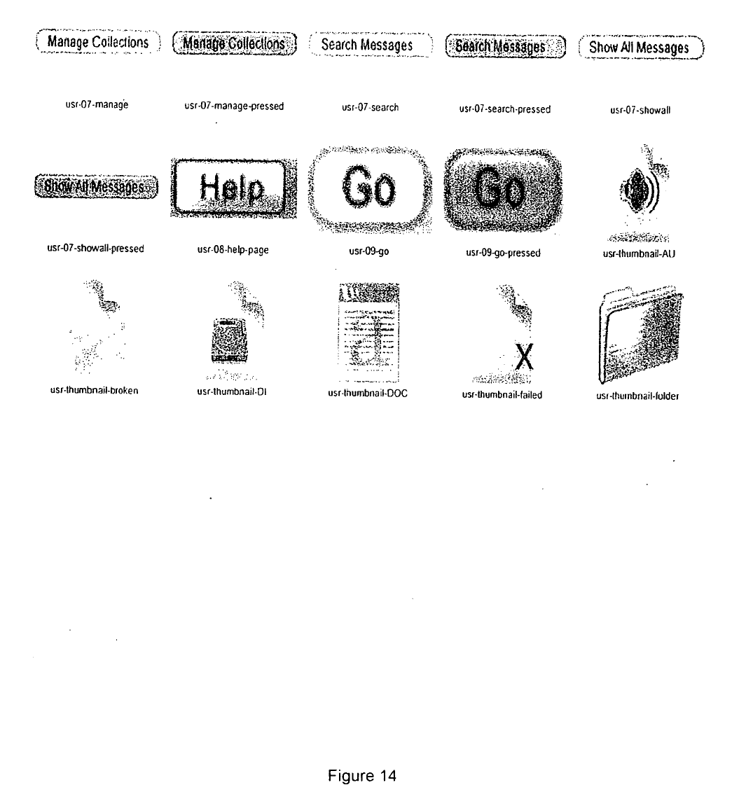

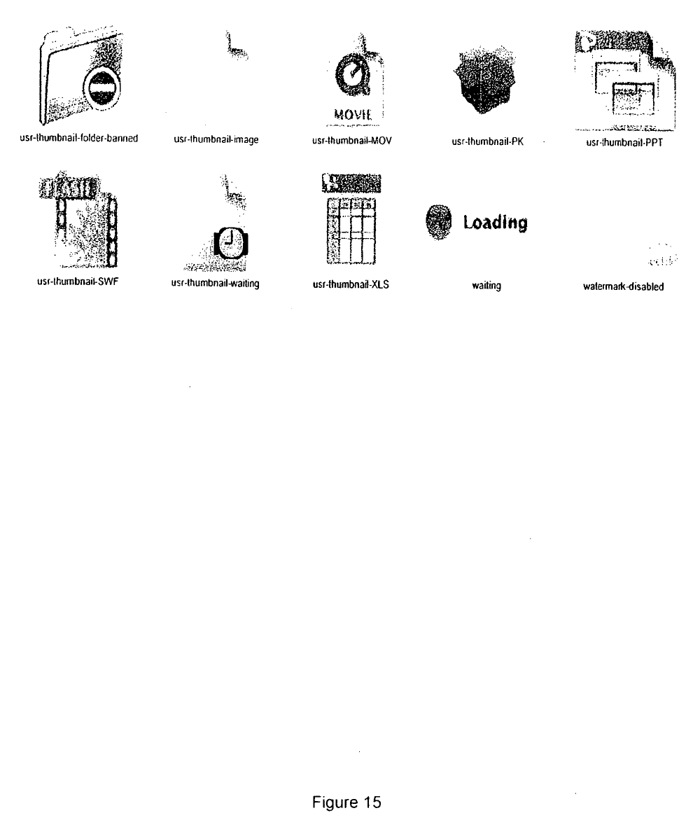

In various embodiments, the portion of the webpage dedicated to the messaging area can be modified by the user, by means of a default preference setting or other element of the webpage user interface. In FIG. 11, an embodiment is shown in which using the mouse to drag a small black square icon has resulted in dynamic resizing of the messaging area.

In various embodiments, the messaging area includes links to the files or directories to which the messages refer. When a link is selected by the user, the website is updated to present the file or directory to which that message refers, and the contents of the messaging area are updated to present only those messages which pertain to that file or directory.

In various embodiments, the messaging area can be relayed automatically to a standard email server, for sending to email addresses specified within the system.

In various embodiments, the messaging area can be relayed automatically to a standard email server, for sending to email addresses specified within the system.

In various embodiments, the messaging area can include replies to previous messages that have been relayed automatically from a standard email server.

In various embodiments, the system includes software that can specify one or more files or directories for which all new messages posted will automatically be relayed to their email address.

In various embodiments, the logo displayed by the system is dependent upon the username and password provided by the user at the time of login.

An example of a preferred embodiment of a computer program and source code for the digital asset management system is contained on CD-ROM disk submitted in U.S. Provisional Patent Application Ser. No. 60/661,141, entitled “Digital Image Management and Collaboration System”, filed Mar. 11, 2005. The above-mentioned CD-ROM disk, and application including computer source code are herein incorporated by reference.

Another preferred embodiment of a computer program and source code for the digital asset management system is contained on CD-ROM disk submitted with this application and is herein incorporated by reference into the present disclosure. The CD-ROM includes all files needed for complete installation of the server software, including full readable source code, on any standard Macintosh computer running OSX 10.3 or 10.4. The files in the backup/restore folder denoted 050309.tar are the embodiment at the time of Provisional Patent Application Ser. No. 60/661,141; the files in the backup/restore folder denoted 060311.tar are another embodiment, current as of the time of this application. A third file also included for convenience on the CD-ROM, MySQL_installer.dmg, does not contain proprietary code unique to this application but must be installed for the current embodiments to function. A fourth file included on the CD-ROM, SeeFile.html, describes the sequence for standard installation of either embodiment.

It will be apparent to those skilled in the art that various modifications and variations can be made to various embodiments described herein without departing from the spirit or scope of the teachings herein. Thus, it is intended that various embodiments cover other modifications and variations of various embodiments within the scope of the present teachings.

What is claimed is:

1. A digital asset management system for viewing digital assets across a computer network, including between at least two users, the system comprising: (a) a computer network capable of receiving, viewing, storing and distributing a digital asset, the computer network having a first set of rules requiring the at least two user's password and identification before allowing viewing of the digital asset; (b) a web-user interface coupled to the computer network, the web-user interface allowing display on a website of a message and/or customer logo associated with the digital image, the web-user interface comprising i) a message display area capable of displaying a message and/or logo transmitted by the at least two users, and ii) an image display area capable of displaying the digital image from at least one user.

2. A digital asset management system according to claim 1, wherein the system tracks new messages and/or images displayed via a network monitoring tool on the network and sends at least one user a message alerting the user that a new messages and/or images has been displayed.

3. A digital asset management system according to claim 1, wherein the digital asset is displayed by the web-user interface by means of a login session.

4. A digital asset management system according to claim 1, wherein the web-user interface comprises a web page where part of the web page displays a messaging area for messages from at least one user.

5. A digital asset management system according to claim 4, wherein the messaging area is present in a plurality of views, which can be selected by at least one user.

6. A digital asset management system according to claim 4, wherein the messaging area displays only messages, which pertain to files being displayed on the webpage.

7. A digital asset management system according to claim 4, wherein the messaging area can be modified by the user, by means of a default preference setting of the web-user interface.

8. A digital asset management system according to claim 4, wherein the messaging area comprises links to the files or directories to which the messages refers and wherein, when the link is selected by the user, the website is updated to present the file or directory to which that message refers, and the contents of the messaging area are updated to present only those messages which pertain to the files or directories.

9. A digital asset management system according to claim 4, wherein the messages displayed in the messaging area can be relayed automatically to an email server, for sending to email addresses specified within the system.

10. A digital asset management system according to claim 9, wherein the messaging area can include replies to previous messages that have been relayed automatically from the email server.

11. A digital asset management system according to claim 1, wherein at least one user can specify one or more files or directories for which all new messages posted will automatically be transmitted to other user via e-mail.

12. A digital asset management system according to claim 1, wherein a portion of the website is devoted to a user logo.

13. A digital asset management system according to claim 1, wherein the logo displayed by the system is dependent upon the username and password provided by the user at a time of login.
